(19) United States
(12) Patent Application Publication
(10) Pub. No.: US 2016/0314525 A1
(43) Pub. Date: Oct. 27, 2016

(54) Net Offer Bidding Platform

(71) Applicant: BidLion, LLC, Manassas, VA (US)

(72) Inventor: Stanley Perry DULL, Manassas, VA (US)

(21) Appl. No.: 15/090,854

(22) Filed: Apr. 5, 2016

Related U.S. Application Data
(60) Provisional application No. 62/151,803, filed on Apr. 23, 2015.

(51) Int. Cl. G06Q 30/08

(52) U.S. Cl. CPC G06Q 30/08; G06Q 50/16

(57) ABSTRACT

Systems, methods, and devices of the various embodiments may provide a real-estate offer and bidding platform. The real-estate offer and bidding platform may allow all buyers to view the terms that impact the net offer and the net offers of their competition. The real-estate offer and bidding platform may allow buyers to compete not only on the gross offer, but also the net offer, and the terms that impact the net offer. Various embodiments may include methods, systems, and devices for receiving an offer form indicating one or more terms of a bid for a property from a real estate buyer computing device at a server hosting a net offer bidding platform, determining a net offer for the bid based on the indicated one or more terms at the server, and displaying the determined net offer for the bid in a bid table associated with the property.

### RELATED APPLICATIONS

The present application claims priority to U.S. Provisional Patent Application No. 62/151,803 entitled “Net Offer Bidding Platform” filed Apr. 23, 2015, the entire contents of which are hereby incorporated by reference.

### BACKGROUND

Currently when a real estate buyer wishes to purchase a property (e.g., a home, building, lot, etc.), one approach available to the real estate buyer is to use an online real estate auction or listing services. Existing online auction style platforms only show the gross offer and do not work for traditional real-estate sales because the current online auction style platforms are not able to show the many variables that affect the value of each offer. Existing online auction style platforms work for investors and cash buyers only. Current online real estate auction or listing services do not display the many variable terms that impact the value of a bid and do not display net offers for a property. Thus, current online real estate auction or listing services do not provide a fair and transparent process for real estate buyers or property sellers and do not account for many of the variable terms associated with real estate transactions.

### SUMMARY

The systems, methods, and devices of the various embodiments may provide a paperless real-estate offer and bidding platform. The embodiment real-estate offer and bidding platform may allow all buyers to view the terms that impact the net offer and the net offers of their competition. The embodiment real-estate offer and bidding platform may allow buyers to compete not only on the gross offer, but also the net offer, and the terms that impact the net offer, such as: the seller subsidy (buyer expenses paid by the seller-insurance, taxes, points, closing fees, etc.); loan type; home warranty; days to close; earnest money deposit; cash down; and/or inspections, which all impact the value of each net offer. The embodiment real-estate offer and bidding platform may determine the winning bidder/offer by the best net offer as opposed to the gross offer.

The embodiment real-estate offer and bidding platform may give every buyer equal information about other offers and a fair process to bid back and forth on the terms and net price in order to submit the best offer within a designated offer period.

The embodiment real-estate offer and bidding platform may be a non-binding, letter-of-intent-style real-estate offer platform. However, the embodiment real-estate offer and bidding platform may also be used by auctioneers or real-estate agents as a binding contract by attaching terms to that effect.

The embodiment real-estate offer and bidding platform may be a tool for realtors that allows buyers from multiple locations to submit paperless offers online that have the details required for a traditional real estate transaction and then allows the buyers to compete back and forth on the terms and net offers in order to submit the best offer.

In various embodiments, the real-estate offer and bidding platform may provide a real life bid history that shows how buyers improved their offers multiple times by reducing their seller subsidy, days to close and home warranty and by increasing their Ernest Monet Deposit (EMD), cash down, and Net Offer.

The embodiment real-estate offer and bidding platform may allow buyers to compete on the terms and net price online from multiple locations.

Other embodiment real-estate offer and bidding platform features may include enabling buyers to receive automatic email alerts when they are outbid; extending the offer period by 3 to 5 minutes if a bid is received within 5 minutes of the end of the offer period to prevent last second bids that keep other buyers from bidding to their full capacity; and/or enabling buyers to bid on properties online from different locations.

Various embodiments may include methods, systems, and devices for receiving an offer form indicating one or more terms of a bid for a property from a real estate buyer computing device at a server hosting a net offer bidding platform, determining a net offer for the bid based on the indicated one or more terms at the server, and displaying the determined net offer for the bid in a bid table associated with the property.

### DESCRIPTION OF THE DRAWINGS

The accompanying drawings, which are incorporated herein and constitute part of this specification, illustrate exemplary embodiments of the invention, and description given above and below, serve to explain the features of the invention.

FIG. 1 is a system block diagram of a network suitable for use with the various embodiments.

FIG. 2 is a process flow diagram illustrating an embodiment method for displaying property seller menus or bid menus in a net offer bidding platform.

FIG. 3 is a process flow diagram illustrating an embodiment method for displaying a listing on a property seller computing device in a net offer bidding platform.

FIG. 4 is a process flow diagram illustrating an embodiment method for displaying a listing on a real estate buyer computing device in a net offer bidding platform.

FIG. 5 is an example screen shot of a listing according to an embodiment.

FIG. 6 is an example screen shot of a bid table according to an embodiment.

FIGS. 7A and 7B are process flow diagrams illustrating an embodiment method for displaying a listing on a property seller computing device or a real estate buyer computing device in a net offer bidding platform.

FIG. 8 is a process flow diagram illustrating an embodiment method for managing bids in a net offer bidding platform.

FIG. 9 is a process flow diagram illustrating an embodiment method for determining a winning bid in a net offer bidding platform.

FIG. 10 is a component diagram of an additional example computing device suitable for use with the various embodiments.

FIG. 11 is a component diagram of an example server suitable for use with the various embodiments.

### DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used to refer to any one or all of desktop computers, cellular telephones, smart phones, personal or mobile multi-media players, personal data assistants (PDA's), laptop computers, tablet computers, smart books, retail terminals, palm-top computers, wireless electronic mail receivers, multimedia Internet enabled cellular telephones, wireless gaming controllers, and similar electronic devices which include a programmable processor and memory and circuitry for receiving user input and rendering data, such as web pages.

The various embodiments are described herein using the term “server.” The term “server” is used to refer to any computing device capable of functioning as a server, such as a master exchange server, web server, mail server, document server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

The systems, methods, and devices of the various embodiments provide a net offer bidding platform enabling real estate buyers to submit net offers for a property (home, building, lot, etc.). In various embodiments, a real estate buyer may vary one or more terms comprising his or her respective net offers. In an embodiment, while an offer period has not expired, a real estate buyer may view the other competing net offers submitted for a property and update his or her net offer. The various embodiments enable a property seller to select an offer from the submitted net offers as a winning offer. In various embodiments, the net offer bidding platform may enable a property seller to generate a contract including terms corresponding to the terms of the winning offer.

The various embodiments may provide a paperless real-estate offer and bidding platform that may allows all real estate buyers interested in a given property to view the terms and net offers of the other real estate buyers interested in the property, allowing them to compete not only on the gross offer (e.g., purchase price), but the seller subsidy (e.g., buyer expenses paid by the seller, such as insurance, taxes, points, closing costs, etc.), loan type, home warranty, days to close, earnest money deposit, cash down, and inspections among other terms, which all effect the net value of each offer. The various embodiments determine the winning bidder by the best net offer (e.g., the highest net offer). The various embodiments provide a transparent offer platform that may give every buyer equal information about other offers and a fair process to bid back and forth on the terms and net price in order to submit the best offer.

In the various embodiments, a real estate buyer may receive automatic alerts, such as e-mail alerts, when he or she is outbid for a property. In this manner, potential buyers may be driven back to the portal to adjust the terms on a previous bid to continue to attempt to win (e.g., purchase) a property. The network based nature of the portal of the various embodiments may enable buyers to bid from any location.

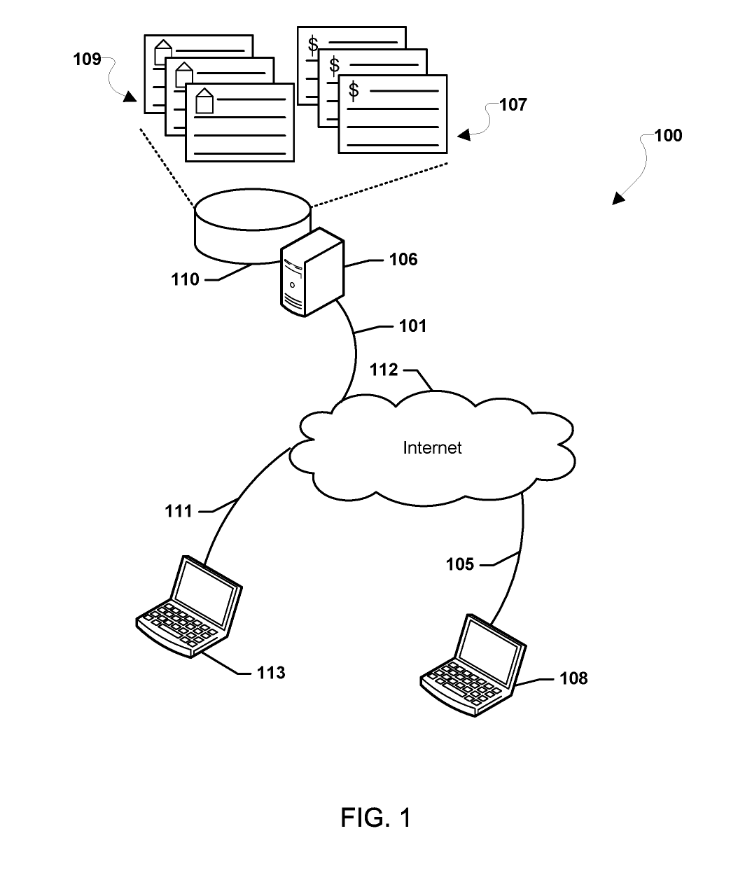

FIG. 1 is a system block diagram of a network suitable for use with the various embodiments. For ease of discussion, many of the embodiments are discussed in relation to bids or offers for property, such as a home, building, lot, etc. However, the embodiments discussed herein may be applied to any of a variety of properties. The network system 100 may include multiple devices, such as a one or more real estate buyer computing device 108, one or more seller computing device 113, and one or more server hosting a net offer bidding platform 106 connected to a network, such as the Internet 112. As an example, the real estate buyer computing device 108 and/or the seller computing device 113 may be a laptop, tablet, desktop, mobile device, etc., operated by real estate buyer or property seller desiring to buy or sell a property, respectively. The real estate buyer computing device 108 and/or the seller computing device 113 may include a network interface enabling the real estate buyer computing device 108 and/or the seller computing device 113 to establish a network connection 105, 111, respectively, such as a wired or wireless connection via a router and/or base station, to a network, such as the Internet 112. The real estate buyer computing device 108 and/or the seller computing device 113 may run an application on a processor of the real estate buyer computing device 108 and/or the seller computing device 113, such as a web browser, enabling the real estate buyer computing device 108 and/or the seller computing device 113 to access the server hosting a net offer bidding platform 106. In the various embodiments, the real estate buyer computing device 108 and/or the seller computing device 113 may execute various scripts, modules, applications, etc., such as Hypertext Markup Language (HTML), JavaScript, etc. to provide data (e.g., HTTP requests, forms and form data, etc.) to the server hosting a net offer bidding platform 106 and to request data (e.g., web pages, forms, etc.) from the server hosting a net offer bidding platform 106.

The server hosting a net offer bidding platform 106 may include a network interface enabling the retailer server 106 to establish a network connection 101, such as a wired or wireless connection via a router and/or base station, to a network, such as the Internet 112. In this manner, via their connections to the network, such as the Internet 112, the real estate buyer computing device 108, the seller computing device 113, and/or the server hosting a net offer bidding platform 106 may exchange data with one another.

The server hosting a net offer bidding platform 106 may access one or more database 110 of property information, including listing records 109 and bid records 107. In the various embodiments, listing records 109 may be one or more records associated with properties available for sale via the net offer bidding platform, and may include singular or correlated data records for various properties. For example, a listing record 109 for a property may be a correlated collection of data for a property stored in the database 110 including property information (e.g., address, year built, room numbers, room type, lot size, multiple listing service (MLS) listing number, asking price, etc.), pictures or the property, documents related to the property, agent information, etc. In the various embodiments, bid records 107 may be one or more record associated with bids or offers submitted by potential real estate buyers for a property for sale via the net offer bidding platform. Each bid record 107 may be associated with a property and/or a real estate buyer and may indicate terms of the buyer's bid, such as a seller subsidy term (e.g., an insurance cost, tax cost, points, or closing cost, etc.), a loan type term, a home warranty term, a days to close term, an earnest money deposit term, a cash down term, an inspection term, etc. Based on the terms of the buyer's bid the net offer bidding platform 106 may determine a net offer associated with the bid, and the determined net offer may be indicated in the bid record 107.

The server hosting a net offer bidding platform 106 may manage/update the information within the database 110 (e.g., records 107 and/or 109) and/or make the information from the database 110 available to other devices as well as perform operations using the information within the database 110 and provided from other devices. For example, in response to requests for web pages received from the real estate buyer computing device 108 and/or the seller computing device 113 (e.g., HTTP Get( ) requests for a uniform resource locator (URL) associated with a log-in page, menu pages, property listing page, etc.), the server hosting a net offer bidding platform 106 may update information in the database 110 using various server side operations, modules, scripts, etc., such as PHP operations, to update and/or gather information within the database 110 (e.g., records 107 and/or 109). The server hosting a net offer bidding platform 106 may then display the results of the updating and/or gathering of the information by serving data (e.g., web pages, objects, scripts, etc.) to the real estate buyer computing device 108 and/or the seller computing device 113 to cause the real estate buyer computing device 108 and/or the seller computing device 113 to display information via the application running on a processor of the real estate buyer computing device 108 and/or the seller computing device 113, such as a web browser, and the display of the real estate buyer computing device 108 and/or the seller computing device 113. In this manner, the real estate buyer computing device 108 and/or the seller computing device 113 may actively present the net offer bidding platform to the real estate buyer and/or seller, respectively.

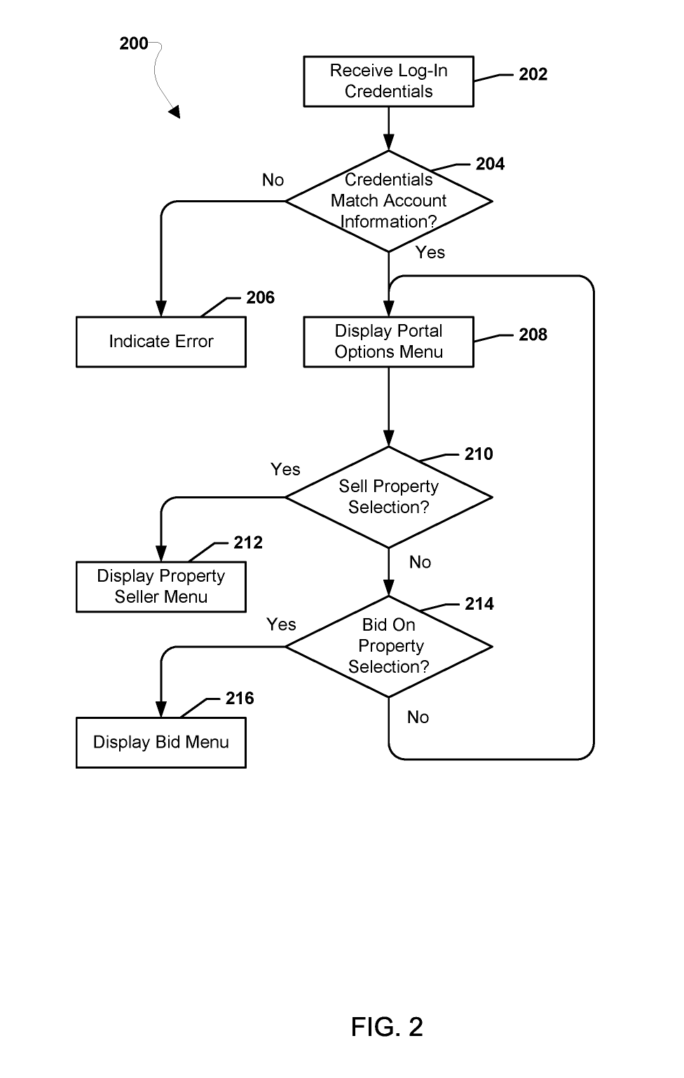

FIG. 2 is a process flow diagram illustrating an embodiment method 200 for displaying property seller menus or bid menus in a net offer bidding platform. In an embodiment, the operations of method 200 may be performed by a processor of a computing device or by processors of a series of computing devices. For example, the processor of the server hosting a net offer bidding platform 106 may perform the operations of method 200 through data exchanges with the processor of the real estate buyer computing device 108 and/or the processor of the seller computing device 113.

In block 202 the processor may receive log-in credentials. As an example, via the connection 101 to the Internet 112, the processor of the server hosting a net offer bidding platform 106 may receive a user name and password indication of a real estate buyer or a property seller from the processor of the real estate buyer computing device 108 and/or the processor of the seller computing device 113, respectively. In determination block 204 the processor may determine whether the credentials match account information. For example, the processor of the server hosting the net offer bidding platform 106 may compare the user name and password to a list of stored user names and passwords to determine whether there is a match. In response to determining the credentials do not match account information (i.e., determination block 204=“No”), in block 206 the processor may indicate an error.

In response to determining the credentials do match account information (i.e., determination block 204=“Yes”), in block 208 the processor may display a portal options menu. For example, the processor of the server hosting the net offer bidding platform 106 may serve a web page including options to sell property or bid on property to a real estate buyer or a property seller from the processor of the real estate buyer computing device 108 and/or the processor of the seller computing device 113 via the Internet 112, and the processor of the real estate buyer computing device 108 and/or the processor of the seller computing device 113 may render the web page to present the menu options to the real estate buyer or seller.

In determination block 210 the processor may determine whether a sell property selection is received. As an example, a sell property selection may be an indication that a radio button, selectable graphic, or other selection object associated with selling property was clicked on by a real estate buyer or seller sent from the processor of the real estate buyer computing device 108 and/or the processor of the seller computing device 113 to the processor of the server hosting the net offer bidding platform 106. In response to receiving a sell property selection (i.e., determination block 210=“Yes”), in block 212 the processor may display a property seller menu. For example, the processor of the server hosting the net offer bidding platform 106 may serve a web page including options to create, update, and/or display listing to the processor of the seller computing device 113 via the Internet 112, and the processor of the seller computing device 113 may render the web page to present the options to the seller.

In response to not receiving a sell property selection (i.e., determination block 210=“No”), in block 214 the processor may determine whether a bid on property selection is received. As an example, a bid on property selection may be an indication that a radio button, selectable graphic, or other selection object associated with buying property was clicked on by a real estate buyer or seller sent from the processor of the real estate buyer computing device 108 and/or the processor of the seller computing device 113 to the processor of the server hosting the net offer bidding platform 106. In response to receiving a bid on property selection (i.e., determination block 214=“Yes”), in block 216 the processor may display a bid menu. For example, the processor of the server hosting the net offer bidding platform 106 may serve a web page including options to select and/or display listings to the processor of the real estate buyer computing device 108 via the Internet 112, and the processor of the real estate buyer computing device 108 may render the web page to present the options to the buyer. In response to not receiving a bid on property selection (i.e., determination block 214=“No”), in block 208 the processor may continue to display the portal options menu as discussed above.

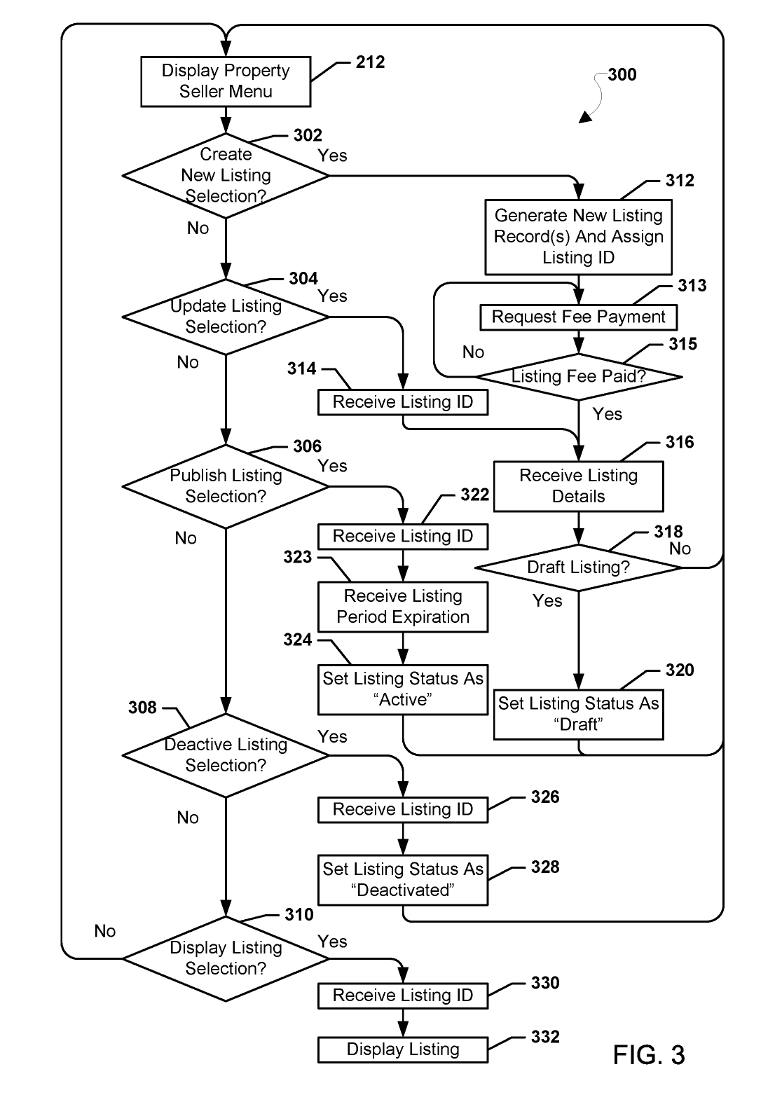

FIG. 3 is a process flow diagram illustrating an embodiment method 300 for displaying a listing on a property seller computing device in a net offer bidding platform. In an embodiment, the operations of method 300 may be performed by a processor of a computing device or by processors of a series of computing devices. For example, the processor of the server hosting a net offer bidding platform 106 may perform the operations of method 300 through data exchanges with the processor of the seller computing device 113. In various embodiments, the operations of method 300 may be performed in conjunction with the operations of method 200 of FIG. 2 described above.

As discussed above, in block 212 the processor may display the property seller menu. In determination block 302 the processor may determine whether a create new listing selection is received. As an example, a create new listing selection may be an indication that a radio button, selectable graphic, or other selection object associated with creating a new listing for a property was clicked on by a seller sent from the processor of the seller computing device 113 to the processor of the server hosting the net offer bidding platform 106. In response to receiving a create new listing selection (i.e., determination block 302=“Yes”), in block 312 the processor may generate one or more new listing records and assign a listing identifier to the listing. In block 313 the processor may request a fee payment to host the listing. For example, the processor of the server hosting the net offer bidding platform 106 may send an indication to the processor of the seller computing device 113 to display an indication of the listing fee and a method of payment (e.g., credit card information, Pay-pal account, etc.) for the fee. In determination block 315 the processor may determine whether the listing fee is paid. In response to determining the fee is not paid (i.e., determination block 313=“No”), the processor may continue to request fee payment in block 313 without listing the property.

In response to determining the fee is paid (i.e., determination block 315=“Yes”), in block 316 the processor may receive listing details. In the various embodiments, receiving listing details may include receiving indications of property information (e.g., address, year built, room numbers, room type, lot size, multiple listing service (MLS) listing number, asking price, etc.), pictures of the property, documents related to the property, agent information, etc., uploaded to the portal by the seller via his or her computing device that may then be stored in the listing records. In determination block 318 the processor may determine whether the status for the listing is indicated as a draft listing by the seller. In various embodiments, the listings may be tracked based on the status in the buying and selling process. Draft listing may be those listing that the seller has not indicated has open for bidding on or sale yet, and that may not be ready to be published to potential buyers. In response to determining the listing is a draft listing (i.e., determination block 318=“Yes”), in block 320 the processor may set the listing status as “draft”. In response to determining the listing is not a draft listing and will be published (i.e., determination block 318=“No”) or upon setting the listing as a draft listing in block 320, the processor may return to block 212.

In response to not receiving a create new listing selection (i.e., determination block 302=“No”), in determination block 304 the processor may determine whether an update listing selection is received. As an example, an update listing selection may be an indication that a radio button, selectable graphic, or other selection object associated with updating a listing for a property was clicked on by a seller sent from the processor of the seller computing device 113 to the processor of the server hosting the net offer bidding platform 106. In response to receiving an update listing selection (i.e., determination block 304=“Yes”), in block 314 the processor may receive the listing ID, for example in response to the seller clicking a drop down menu of his or her listings or entering a listing number in a text entry field. As discussed above the processor may perform operations of blocks 316, 318, and 320 and return to block 212.

In response to not receiving an update listing selection (i.e., determination block 304=“No”), in determination block 306 the processor may determine whether a publish listing selection is received. As an example, a publish listing selection may be an indication that a radio button, selectable graphic, or other selection object associated with publishing a listing for a property was clicked on by a seller sent from the processor of the seller computing device 113 to the processor of the server hosting the net offer bidding platform 106. In response to receiving a publish listing selection (i.e., determination block 306=“Yes”), in block 322 the processor may receive the listing ID, for example in response to the seller clicking a drop down menu of his or her listings or entering a listing number in a text entry field. In block 323 the processor may receive a listing period expiration. In an embodiment, the listing period expiration may be an indication provided by the seller of date and/or time at which the listing should close and the winning bid should be determined for the property. As an example, a listing period expiration may be an indication of a date selected from a selectable calendar or a date and/or time entered in a text entry field sent from the processor of the seller computing device 113 to the processor of the server hosting the net offer bidding platform 106. In block 324 the processor may set the listing status as “active”. In an embodiment, the active status may be indicated by a value recognized by the server as equated with an active listing, including a null value. In response to setting the listing as active, the processor may return to block 212.

In response to not receiving a publish listing selection (i.e., determination block 306=“No”), in determination block 308 the processor may determine whether a deactivate listing selection is received. As an example, a deactivate listing selection may be an indication that a radio button, selectable graphic, or other selection object associated with withdrawing a listing for a property from bidding was clicked on by a seller sent from the processor of the seller computing device 113 to the processor of the server hosting the net offer bidding platform 106. In response to receiving a deactivate listing selection (i.e., determination block 308=“Yes”), in block 326 the processor may receive the listing ID, for example in response to the seller clicking a drop down menu of his or her listings or entering a listing number in a text entry field. In block 328 the processor may set the listing status as “deactivated”. In an embodiment, the deactivated status may be indicated by a value recognized by the server as equated with an inactive listing. In response to setting the listing as deactivated, the processor may return to block 212.

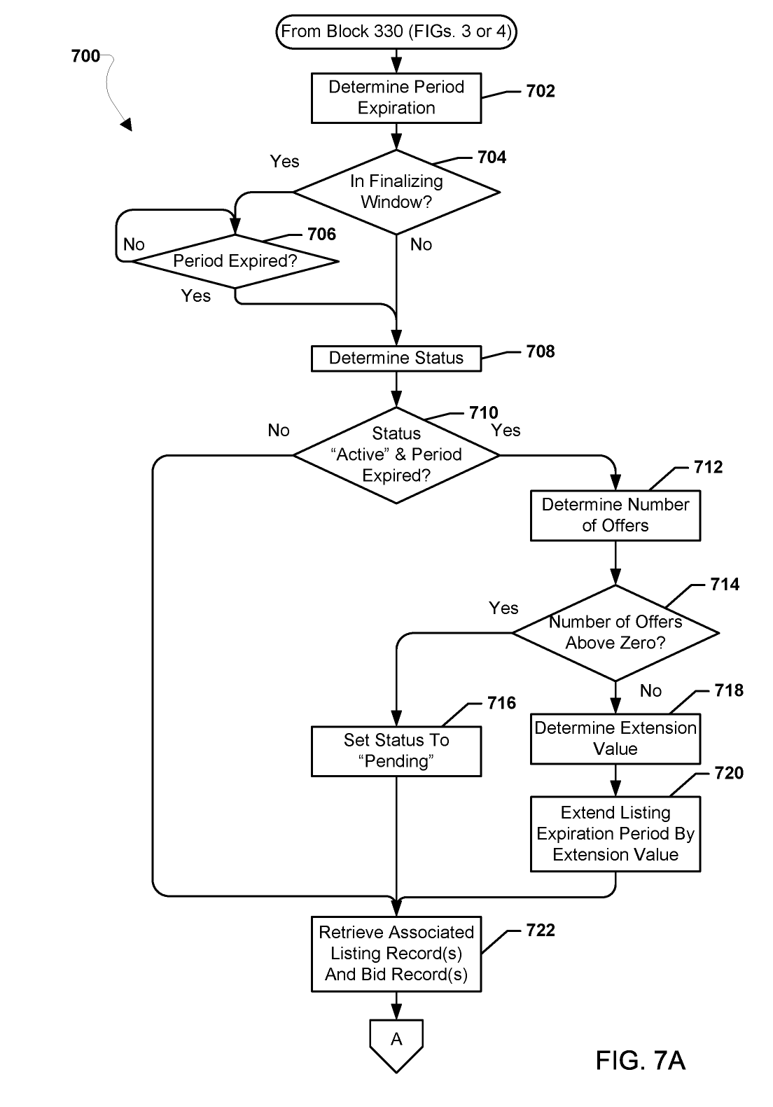

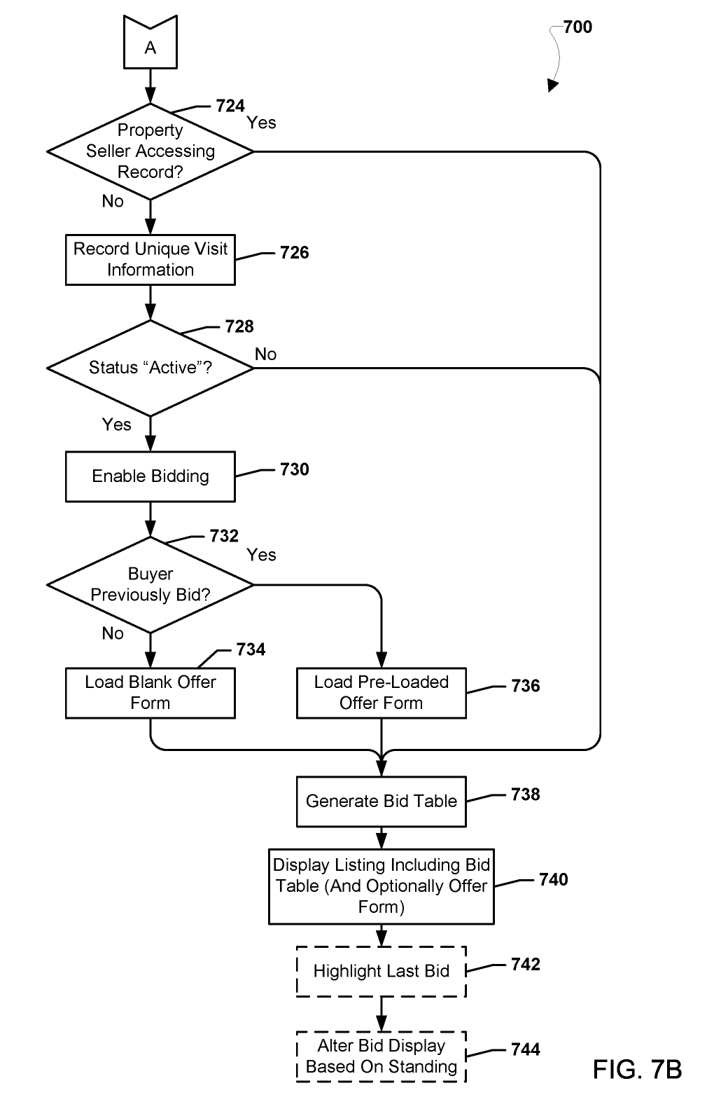

In response to not receiving a deactivate listing selection (i.e., determination block 308=“No”), in determination block 310 the processor may determine whether a display listing selection is received. As an example, a display listing selection may be an indication that a radio button, selectable graphic, or other selection object associated with displaying a listing for a property was clicked on by a seller sent from the processor of the seller computing device 113 to the processor of the server hosting the net offer bidding platform 106. In response to not receiving a display listing selection (i.e., determination block 310=“No”), the processor may return to block 212. In response to receiving a display listing selection (i.e., determination block 310=“Yes”), in block 330 the processor may receive the listing ID, for example in response to the seller clicking a drop down menu of his or her listings or entering a listing number in a text entry field. In block 332 the processor may display the listing. For example, the processor may display the listing as discussed further below with reference to FIGS. 7A and 7B.

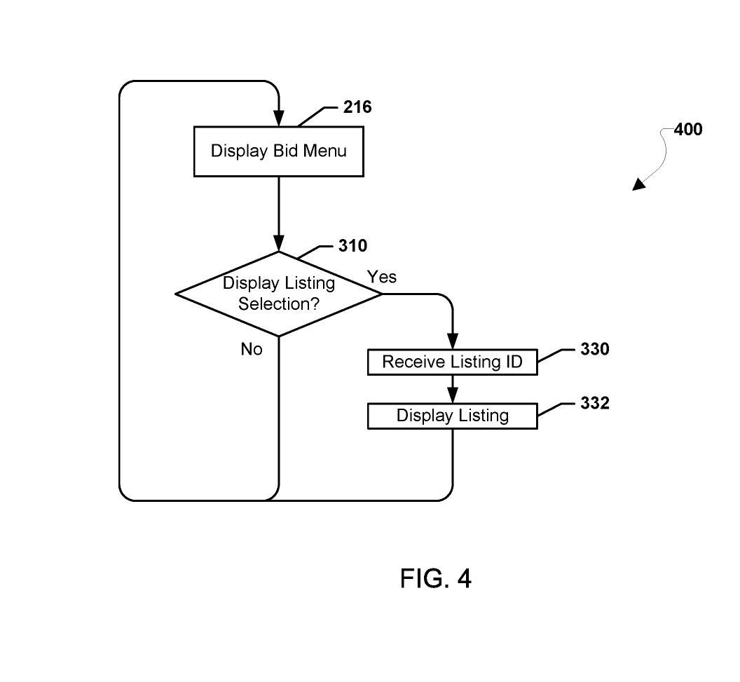

FIG. 4 is a process flow diagram illustrating an embodiment method 400 for displaying a listing on a real estate buyer computing device in a net offer bidding platform. In an embodiment, the operations of method 400 may be performed by a processor of a computing device or by processors of a series of computing devices. For example, the processor of the server hosting a net offer bidding platform 106 may perform the operations of method 400 through data exchanges with the processor of the real estate buyer computing device 108. In various embodiments, the operations of method 400 may be performed in conjunction with the operations of method 200 and/or 300 of FIGS. 2 and 3, respectively, described above.

As discussed above, in block 216 the processor may display a bid menu. In determination block 310 the processor may determine whether a display listing selection is received. As an example, a display listing selection may be an indication that a radio button, selectable graphic, or other selection object associated with displaying a listing for a property was clicked on by a buyer sent from the processor of the real estate buyer computing device 108 to the processor of the server hosting the net offer bidding platform 106. In response to not receiving a display listing selection (i.e., determination block 310=“No”), the processor may return to block 216. In response to receiving a display listing selection (i.e., determination block 310=“Yes”), in block 330 the processor may receive the listing ID, for example in response to the buyer searching for listing and selecting listing images from a results page, entering a listing number in a text entry field, etc. In block 332 the processor may display the listing. For example, the processor may display the listing as discussed further below with reference to FIGS. 7A and 7B.

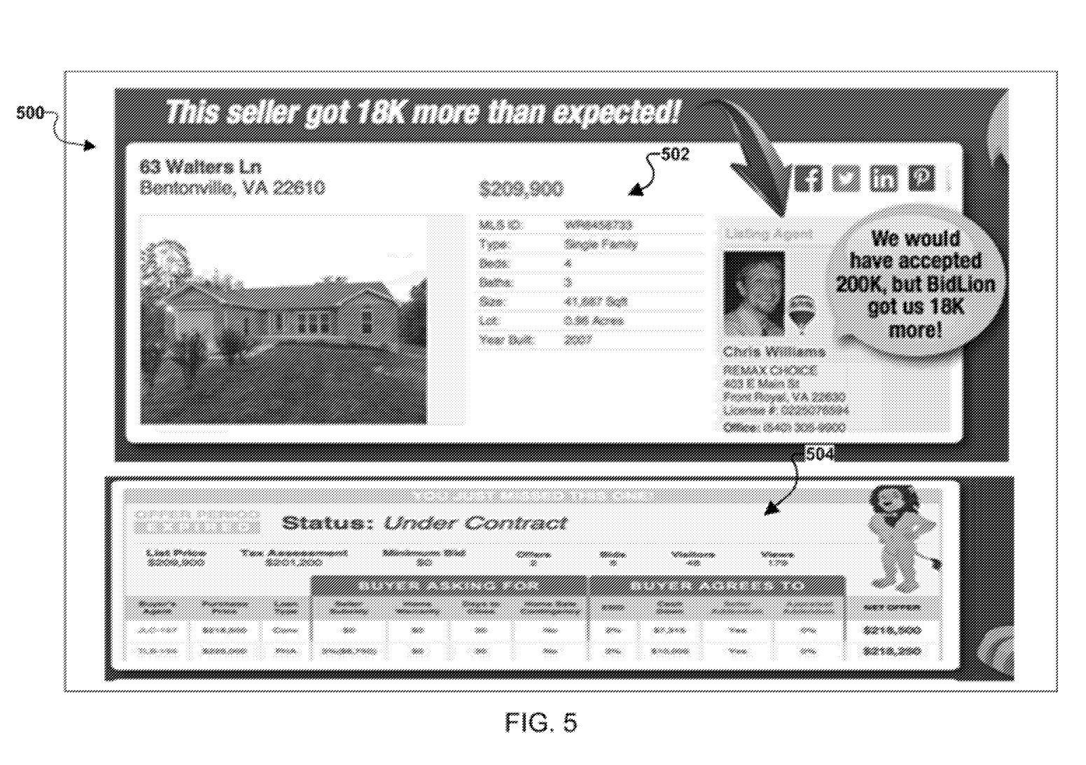

FIG. 5 is an example screen shot of a listing 500 according to an embodiment. The listing 500 may include a listing information tab 502 including information from listing records associated with a property and a bid table 504 including bids reflecting information in bid records associated with the property. The listing information tab 502 may display data from the listing records associated with a property for sale via the net offer bidding platform, including property information (e.g., address, year built, room numbers, room type, lot size, multiple listing service (MLS) listing number, asking price, etc.), pictures or the property, documents related to the property, agent information, etc. The bid table 504 may be generated based on one or more bid records associated with bids or offers submitted by potential real estate buyers for the property for sale via the net offer bidding platform. The bid table may indicate terms of the buyers' bids, such as seller subsidy terms (e.g., an insurance cost, tax cost, points, or closing cost, etc.), loan type terms, home warranty terms, days to close terms, earnest money deposit terms, cash down terms, inspection terms, net offers, etc. Based on the terms of the buyers' bids the net offer bidding platform may determine a net offer associated with each bid, and the determined net offers may be indicated in the bid table 504. In this manner, buyers and sellers may compare net offers in the bid table, and the highest net offer may be selected as the winning bid. In various embodiments, the bid table 504 or the listing information tab 502 may indicate the status of the listing 500, such as “under contract”, “active”, “deactivated”, “sold”, etc.

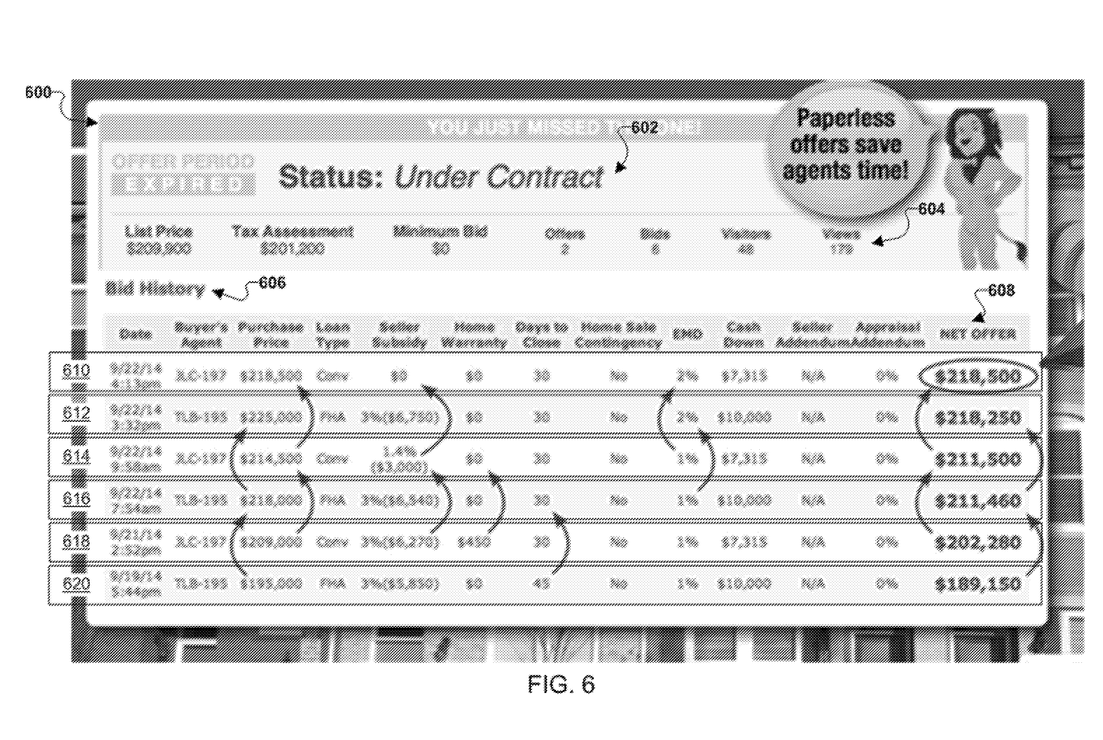

FIG. 6 is an example screen shot of a bid table 600 according to an embodiment. The bid table 600 may be similar to bid table 500 described above. The bid table 600 may indicate the status 602 of the listing, may reflect a number of views 604 of the listing and a bid history 606 of the listing. The bid history 606 may display bids 610, 612, 614, 616, 618, and 620 sorted by net offer 608.

FIGS. 7A and 7B are process flow diagrams illustrating an embodiment method 700 for displaying a listing on a property seller computing device or a real estate buyer computing device in a net offer bidding platform. In an embodiment, the operations of method 700 may be performed by a processor of a computing device or by processors of a series of computing devices. For example, the processor of the server hosting a net offer bidding platform 106 may perform the operations of method 700 through data exchanges with the processor of the real estate buyer computing device 108 or seller computing device 113. In various embodiments, the operations of method 700 may be performed in conjunction with the operations of method 200, 300, and/or 400 of FIGS. 2, 3, and/or 4, respectively, described above. For example, the operations of method 700 may be performed in block 332 of FIG. 3 or 4 to display a listing.

In an embodiment, the operations of method 700 may be performed in response to receiving a listing ID in block 330 of FIG. 3 or 4. In block 702 (FIG. 7A) the processor may determine a period expiration. The period expiration may be a parameter indicated in the listing record associated with the property, for example a date and time entry in a listing record. In determination block 704 the processor may determine whether the listing may be in a finalizing window. In an embodiment, a finalizing window may be a period of time associated with the period expiration, such as five seconds after the period expiration, that may enable any last minute offers or bids to be received before changing a status of a listing. In response to determining the listing is in the finalizing window (i.e., determination block 704=“No”), in determination block 706 the processor may determine whether the period has expired. In response to determining the period has not expired (i.e., determination block 706=“No”), the processor may continue to wait for the period to expire in block 706. The waiting for the period to expire in block 706 may effectively pause the execution of a script or other process for displaying listings to enable a listing to be finalized. In this manner, when the listing is accessed in the finalizing window, the processor may delay action on listing until last minute/bids are received and processed to account for lag times and delays in connections between the various devices.

In response to determining the period has expired (i.e., determination block 706=“Yes”) or in response to determining that the listing is not in the finalizing window (i.e., determination block 704=“No”), in block 704 the processor may determine a status of the listing. For example, the processor may determine a value or other indication representing the status of the listing in a listing record to determine the status. In determination block 710 the processor may determine whether the status of the listing may be active and the period may be expired.

In response to determining the listing is active and the period is expired (i.e., determination block 710=“Yes”), the processor may determine a number of offers received for the listing. For example, the processor may parse the bid records for the listing to count the number of offers or bids in the bid records or count the number of bid records. In determination block 714 the processor may determine whether the number of offers is above zero. In this manner, the processor may ensure listings without at least one bid may not be closed, while any offer received for a property may prevent auto extension of the bid period. While illustrated as zero, other minimum thresholds, such as one, two, three bids, etc. may be substituted for the zero minimum threshold. In response to determining the number of offers is zero (i.e., determination block 714=“No”), the processor may determine an extension value. In an embodiment, a listing's expiration may automatically extend by the extension value, such as at least seven days, when the listing has expired and no less than a threshold number of offers have been received for the property. For example, to determine the extension value the processor may determine how much time has passed since expiration. If it has been longer than seven days, then extending the original expiration merely seven days may update the period expiration to a time which has already past. To prevent this, the processor may determine the minimum number of seven day increments that has passed since expiration by dividing the current time minus the expiration period divided by seven. Then the processor may round up to the next whole number to get a multiplier that may be multiply by seven to get the number of days to add to the period expiration as the extension value. For example, if the page is requested, an extension is needed, and it has been 9 days from expiration, then 9/7=1.29, which may be rounded up to 2 and multiply by 7 to get 14, which is the next 7 day increment past 9 days. In this manner, the processor may then determine the extension value is 14 days. In block 720 the processor may extend the listing expiration period by the extension value.

In response to determining the number of offers is above zero (i.e., determination block 714=“Yes”), the processor may set the status of the listing to “pending” in block 716. In this manner, listings with at least one net offer may be closed for bidding.

Upon setting the status in block 716, extending the listing expiration period in block 720, or in response to determining the status of the listing is not active and the period is not expired (i.e., determination block 710=“No”), in block 722 the processor may retrieve the associated listing records and bid records for the property. For example, the processor may pull listing data such as property information, pictures, documents, and listing agent information from the database 110 as well as bid records for the property.

In determination block 724 (FIG. 7B) the processor may determine whether the user is the property seller accessing his or her own listing. In response to determining the user is not the property seller (i.e., determination block 726=“No”), the processor may record unique visit information for the listing, such as the user's IP address. In block 728 the processor may determine whether the status of the listing is “active”. In response to determining the status is “active” (i.e., determination block 728=“Yes”), the processor may enable bidding in block 730. In determination block 732 the processor may determine whether the buyer has previously bid on the property. For example, the processor may determine whether a bid record associated with the buyer is present in memory. In response to determining the buyer has not previously bid (i.e., determination block 732=“No”), the processor may load a blank offer form in block 734 and in response to determining that the buyer has previously bid (i.e., determination block 732=“Yes”), the processor may load a pre-loaded offer form in block 736. In the various embodiments, an offer form may be a web Tillable form including various fields for entering bid/offer terms, such as seller subsidy terms (e.g., an insurance cost, tax cost, points, or closing cost, etc.), loan type terms, home warranty terms, days to close terms, earnest money deposit terms, cash down terms, inspection terms, net offers, etc. A blank offer form may not include any value is the form, while a pre-loaded offer form may include the previous entered terms of the buyer's last bid already in each blank.

Upon loading the forms in block 734 or 736, in response to determining the user is a property seller accessing his or her own record (i.e., determination block 724=“Yes”), or in response to determining the listing is not active (i.e., determination block 728=“No”), in block 738 the processor may generate a bid table. For example, the processor may generate a bid table by reading terms from all associated bid records for a property and writing the terms into fields of a table. In block 740 the processor may display the listing including the bid table. Additionally, the processor may optionally display the offer form when the user is a buyer. For example, the processor may display the listing including the bid table and optionally the offer form by the processor of the server hosting the net offer bidding platform 106 serving a web page including the listing information tab and the bid table to the processor of the real estate buyer computing device 108 and/or the processor of the seller computing device 113 via the Internet 112, and the processor of the real estate buyer computing device 108 and/or the processor of the seller computing device 113 may render the web page to present the web page including the listing information tab and the bid table. In an optional embodiment, the processor may highlight the last bid of the real estate buyer in the bid table in block 742. In an optional embodiment, the processor may alter the bid display based on bid standing for the real estate buyer, such as by changing colors in the table to reflect standings amongst bidders. For example, a lead bid may be green and a trailing bid may be red. As another example, a blue bid may be a bid being viewed by a party who is not currently a bidder. Additionally, withdrawn bids may not be displayed.

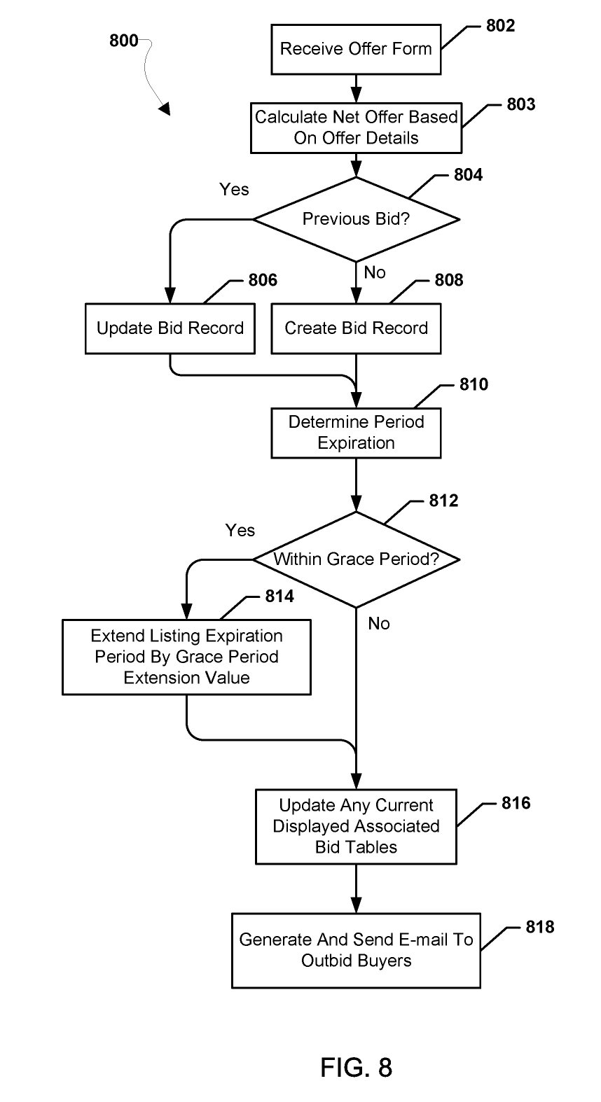

FIG. 8 is a process flow diagram illustrating an embodiment method 800 for managing bids in a net offer bidding platform. In an embodiment, the operations of method 800 may be performed by a processor of a computing device or by processors of a series of computing devices. For example, the processor of the server hosting a net offer bidding platform 106 may perform the operations of method 800 through data exchanges with the processor of the real estate buyer computing device 108. In various embodiments, the operations of method 800 may be performed in conjunction with the operations of method 200, 300, 400, and/or 700 of FIGS. 2, 3, 4, and/or 7A-B, respectively, described above.

In block 802 the processor may receive an offer form. Receiving an offer form may include receiving indications of data entered into a web Tillable form via HTTP Get or Post submissions from a processor of a real estate buyer computing device 108, including various data from fields for entering bid/offer terms, such as seller subsidy terms (e.g., an insurance cost, tax cost, points, or closing cost, etc.), loan type terms, home warranty terms, days to close terms, earnest money deposit terms, cash down terms, inspection terms, etc. In block 803 the processor may calculate a net offer based on the offer details received in the offer form. In the various embodiments, the net offer may be calculated based on one or more of the bid/offer terms, including seller subsidy terms (e.g., an insurance cost, tax cost, points, or closing cost, etc.), loan type terms, home warranty terms, days to close terms, earnest money deposit terms, cash down terms, inspection terms, etc.

In determination block 804 the processor may determine whether the real estate buyer associated with the received form has previously bid on the property. In response to determining the buyer has previously bid (i.e., determination block 804=“Yes”), in block 806 the processor may update the bid record with the bid/offer terms and the calculated net offer. In response to determining the buyer has not previously bid (i.e., determination block 806=“No”), the processor may create a bid record for the buyer and the property in block 808 including the bid/offer terms and calculated net offer.

In block 810 the processor may determine the period expiration for the listing. In block 812 the processor may determine whether the listing is within a grace period of the period expiration. In an embodiment, a grace period may be a time period before the close of a listing in which when a bid is received additional time may be made available for other bidders to bid to their full capacity. For example, the grace period may be five minutes or any other time.

In response to determining that the bid is within the grace period (i.e., determination block 812=“Yes”), in block 814 the processor may extend the listing expiration period by a grace period extension value. A grace period extension value may be a time added to the listing expiration to give other buyers a last chance to bid on a listing. For example, the grace period extension value may be 3 minutes, 5 minutes, 3-5 minutes, more than 5 minutes, etc.

Upon extending the listing expiration or in response to determining the listing is not in the grace period (i.e., determination block 812=“No”), in block 816 the processor may update any current displayed associated bid tables. For example, the processor of the server hosting a net offer bidding platform 106 may send updated table data to update the bid tables displayed by processors of all real estate buyer computing devices 108 actively viewing the listing. In block 818 the processor may generate and send e-mails to the outbid buyers to let them now a higher net offer bid was received.

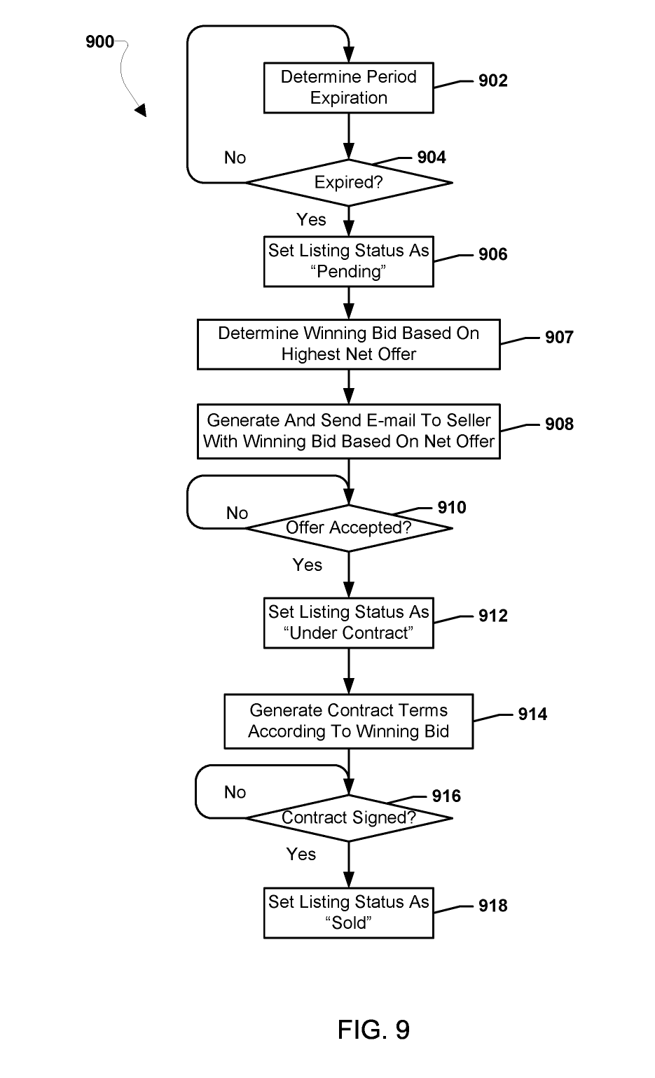

FIG. 9 is a process flow diagram illustrating an embodiment method 900 for determining a winning bid in a net offer bidding platform. In an embodiment, the operations of method 900 may be performed by a processor of a computing device or by processors of a series of computing devices. For example, the processor of the server hosting a net offer bidding platform 106 may perform the operations of method 900 through data exchanges with the processor of the seller computing device 113. In various embodiments, the operations of method 900 may be performed in conjunction with the operations of method 200, 300, 400, 700, and/or 800 of FIGS. 2, 3, 4, 7A-B, and/or 8, respectively, described above.

In block 902 the processor may determine the period expiration for the listing. In determination block 904 the processor may determine whether the period has expired. In response to determining the period has not expired (i.e., determination block 904=“No”), the processor may return to block 902. In response to determining the period has expired (i.e., determination block 904=“Yes”), in block 906 the processor may set the listing status as pending. In block 907 the processor may determine the winning bid based on the highest net offer and in block 908 may generate and send an e-mail to the seller indicating the winning bid based on the net offer.

In determination block 910 the processor may determine whether the offer was accepted by the seller. In response to determining that the offer is not yet accepted (i.e., determination block 910=“No”), the processor may wait for the acceptance by returning to block 910. In response to determining the offer is accepted (i.e., determination block 910=“Yes”), in block 912 the processor may set the listing status as under contract. In block 914 the processor may generate contract terms according to the winning bid. In determination block 916 the processor may determine whether the contract was signed. In response to determining that the contract is not yet signed (i.e., determination block 916=“No”), the processor may wait for the signatures by returning to block 916. In response to determining the contract is signed (i.e., determination block 916=“Yes”), in block 918 the processor may set the listing status as sold.

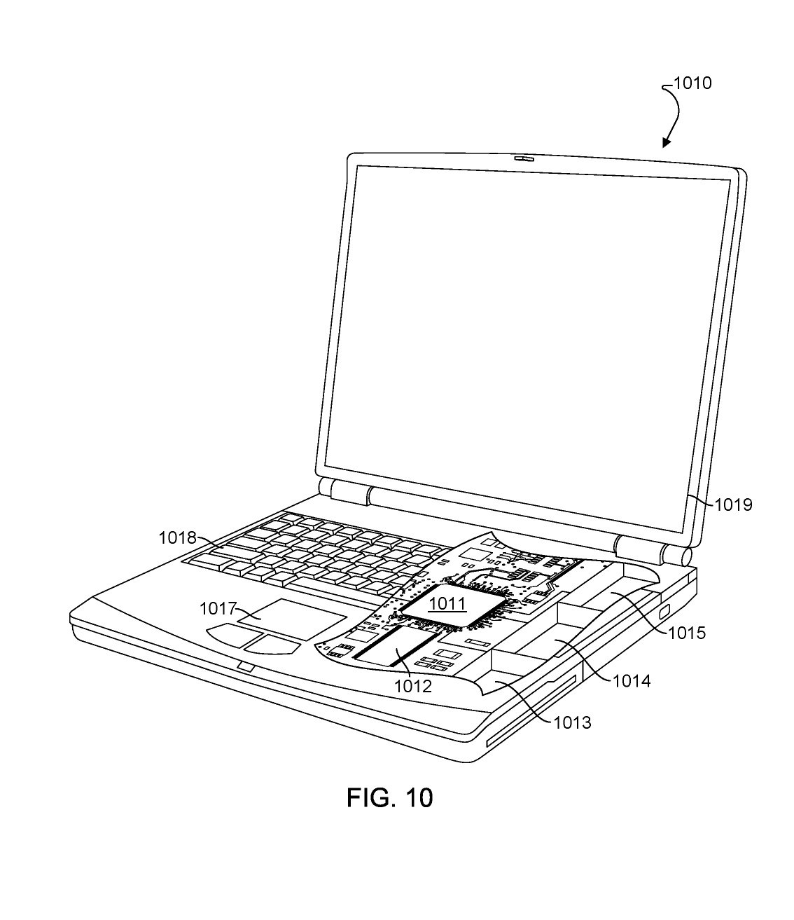

The various embodiments described above may also be implemented within a variety of computing devices, such as a laptop computer 1010 as illustrated in FIG. 10. Many laptop computers include a touch pad touch surface 1017 that serves as the computer's pointing device, and thus may receive drag, scroll, and flick gestures similar to those implemented on mobile computing devices equipped with a touch screen display and described above. A laptop computer 1010 will typically include a processor 1011 coupled to volatile memory 1012 and a large capacity nonvolatile memory, such as a disk drive 1013 of Flash memory. The laptop computer 1010 may also include a floppy disc drive 1014 and a compact disc (CD) drive 1015 coupled to the processor 1011. The laptop computer 1010 may also include a number of connector ports coupled to the processor 1011 for establishing data connections or receiving external memory devices, such as a USB or FireWire® connector sockets, or other network connection circuits (e.g., interfaces) for coupling the processor 1011 to a network. In a notebook configuration, the computer housing may include the touchpad 1017, the keyboard 1018, and the display 1019 all coupled to the processor 1011. Other configurations of the computing device may include a computer mouse or trackball coupled to the processor (e.g., via a USB input) as are well known, which may also be use in conjunction with the various embodiments.

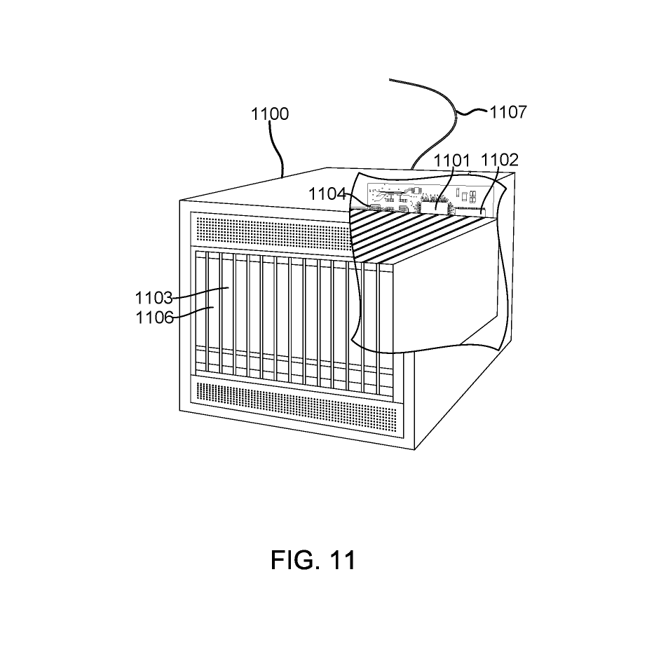

The various embodiments may also be implemented on any of a variety of commercially available server devices, such as the server 1100 illustrated in FIG. 11. Such a server 1100 typically includes a processor 1101 coupled to volatile memory 1102 and a large capacity nonvolatile memory, such as a disk drive 1103. The server 1100 may also include a floppy disc drive, compact disc (CD) or DVD disc drive 1106 coupled to the processor 1101. The server 1100 may also include network access ports 1104 (network interfaces) coupled to the processor 1101 for establishing network interface connections with a network 1107, such as a local area network coupled to other computers and servers, the Internet, the public switched telephone network, and/or a cellular data network (e.g., CDMA, TDMA, GSM, PCS, 3G, 4G, LTE, or any other type of cellular data network).

The processors 1011 and 1101 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 1011 and 1101. The processors 1011 and 1101 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1011 and 1101 including internal memory or removable memory plugged into the device and memory within the processor 1011 and 1101 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method, comprising:
receiving an offer form indicating one or more terms of a bid for a property from a real estate buyer computing device at a server hosting a net offer bidding platform;
determining a net offer for the bid based on the indicated one or more terms at the server; and
displaying the determined net offer for the bid in a bid table associated with the property.

2. The method of claim 1, further comprising:
determining whether a listing period for the property has expired at the server;
determining, at the server, a winning bid from a series of bids for the property as the bid with a higher net offer in response to determining that the listing period for the property has expired; and
notifying a seller computing device of the determined winning bid.

3. The method of claim 2, wherein the bid in the bid table associated with the property includes the indicated one or more terms.

4. The method of claim 3, wherein the indicated one or more terms are selected from the group consisting of a seller subsidy term, a loan type term, a home warranty term, a days to close term, an earnest money deposit term, a cash down term, and an inspection term.

5. The method of claim 4, wherein the seller subsidy term is one or more of an insurance cost, tax cost, points, or closing cost.

6. The method of claim 5, wherein the bid table is displayed on one or both of any real estate buyer computing device and any seller computing device displaying a listing for the property.

7. The method of claim 6, further comprising generating contract terms for the property based on the net offer for the bid and the indicated one or more terms.

8. A server, comprising:
a network interface configured to communicate with a network; and
a processor coupled to the network interface and the display, wherein the processor is configured with processor-executable instructions to perform operations comprising:
receiving an offer form indicating one or more terms of a bid for a property from a real estate buyer computing device;
determining a net offer for the bid based on the indicated one or more terms; and
displaying the determined net offer for the bid in a bid table associated with the property.

9. The server of claim 8, wherein the processor is configured with processor-executable instructions to perform operations further comprising:
determining whether a listing period for the property has expired;
determining a winning bid from a series of bids for the property as the bid with a higher net offer in response to determining that the listing period for the property has expired; and
notifying a seller computing device of the determined winning bid.

10. The server of claim 9, wherein the bid in the bid table associated with the property includes the indicated one or more terms.

11. The server of claim 10, wherein the indicated one or more terms are selected from the group consisting of a seller subsidy term, a loan type term, a home warranty term, a days to close term, an earnest money deposit term, a cash down term, and an inspection term.

12. The server of claim 11, wherein the seller subsidy term is one or more of an insurance cost, tax cost, points, or closing cost.

13. The server of claim 12, wherein the bid table is displayed on one or both of any real estate buyer computing device and any seller computing device displaying a listing for the property.

14. The server of claim 13, wherein the processor is configured with processor-executable instructions to perform operations further comprising generating contract terms for the property based on the net offer for the bid and the indicated one or more terms.

15. A non-transitory processor-readable storage medium having stored thereon processor-executable instructions configured to cause a processor to perform operations comprising:
receiving an offer form indicating one or more terms of a bid for a property from a real estate buyer computing device;
determining a net offer for the bid based on the indicated one or more terms; and
displaying the determined net offer for the bid in a bid table associated with the property.

16. The non-transitory processor-readable storage medium of claim 15, wherein the stored processor-executable instructions are configured to cause a processor to perform operations further comprising:
determining whether a listing period for the property has expired;
determining a winning bid from a series of bids for the property as the bid with a higher net offer in response to determining that the listing period for the property has expired; and
notifying a seller computing device of the determined winning bid.

17. The non-transitory processor-readable storage medium of claim 16, wherein the stored processor-executable instructions are configured to cause a processor to perform operations such that:
the bid in the bid table associated with the property includes the indicated one or more terms; and
the indicated one or more terms are selected from the group consisting of a seller subsidy term, a loan type term, a home warranty term, a days to close term, an earnest money deposit term, a cash down term, and an inspection term.

18. The non-transitory processor-readable storage medium of claim 17, wherein the stored processor-executable instructions are configured to cause a processor to perform operations such that the seller subsidy term is one or more of an insurance cost, tax cost, points, or closing cost.

19. The non-transitory processor-readable storage medium of claim 18, wherein the stored processor-executable instructions are configured to cause a processor to perform operations such that the bid table is displayed on one or both of any real estate buyer computing device and any seller computing device displaying a listing for the property.

20. The non-transitory processor-readable storage medium of claim 19, wherein the stored processor-executable instructions are configured to cause a processor to perform operations further comprising generating contract terms for the property based on the net offer for the bid and the indicated one or more terms.
